(19) United States
(12) Patent Application Publication
(10) Pub. No.: US 2009/0187620 A1
(43) Pub. Date: Jul. 23, 2009

(54) CONVERGED INFORMATION SYSTEMS

(75) Inventors: Andrey Kisel, Berkshire (GB); Dave Cecil Robinson, Wiltshire (GB)

Correspondence Address: FAY SHARPE/LUCENT, 1228 Euclid Avenue, 5th Floor, The Halle Building, Cleveland, OH, 44115-1843, US

(73) Assignee: Alcatel-Lucent via the Electronic Patent Assignment Systems (EPAS)

(21) Appl. No.: 12/356,178

(22) Filed: Jan. 20, 2009

(30) Foreign Application Priority Data
Jan. 21, 2008 (EP) 08290050.7

(51) Int. Cl. G06F 15/16

(52) U.S. Cl. 709/202

(57) ABSTRACT

A notification system for providing notifications to a user equipment (UE) from a plurality of sources using at least two different protocols, over a network, comprising a notification agent arranged to receive notifications from said plurality of notification sources and which are intended for the UE, the notification agent including means for receiving the notifications using a plurality of protocols according to the protocol of the individual sources and for communicating notification to the UE using a single protocol and thereby moving core processing of the notification outside the UE.

This invention relates to converged information systems. In particular, it relates to a system in which user equipment (UE) is used to communicate and receive types of data using many different protocols.

Users of IPTV (Internet Protocol TV) may wish to use many different communication and information technologies. For example, SMS, MMS, IMS (IP multi-media sub-system), IMS-IM, VOIP call, RSS, email, calendar function, instant messaging services such as MSN or Google Talk, internet notification and many other types of services. These generally all involve different protocols. Operators are increasingly interested in offering IPTV users functionality for acting upon notifications from some or all of the notification sources above. That is, when a user is informed of a request or transmission using a particular protocol, they receive a notification and functionality is provided in the UE to enabling the user to choose how to deal with this. These applications are generally referred as ‘converged services’ and these are added value services to traditional IPTV (such as broadcast TV, content on demand or video on demand VOD).

Similarly, users ideally prefer to have multimedia services and communication experience adaptable to their lifestyles. For example, users may wish to receive notifications about high priority email, SMS messages or calls from persons on a ‘buddy list’ on a TV screen and take appropriate response actions.

Existing methods of providing such converged services to a UE may use a gateway from the notification source to the UE and require a separate notification client to be provided at the UE containing notification processing logic particular to each type of communication (SMS, email, VOIP, calendar functionality, etc). For example, for delivering IMS VOIP (session initiation protocol) calls to IP subsystems, a gateway is used to delivery IMS VOIP notifications to an IPTV UE. This gateway can deliver call notifications to the IPTV UE using SIP and a built in client on the UE offers response actions. Typically, the possible options may include: redirect to voicemail, request more information about caller, deny, answer or other.

Another example is email notifications. Notifications of incoming emails are delivered either directly or via the gateway to the UE user, by an email protocol such as POP3, IMAP, SMTP and so on and a different in built client on the UE offers response actions. Typically, these might be reply, read the body, ignore, other. Depending upon the response, the client would then retrieve the text of the email using POP3, IMAP and so on.

The main problem with this existing approach is that it requires a specialised UE client containing specific protocols and notification processing logic for each notification source. This client must be provided on the UE itself. This creates the following limitations.

A new UE client is required to support new notification sources, eg email, SMS, which is not cost efficient in a medium to higher scale deployment,

new notification processing logic is required on the UE to support new notification sources

additional processing logic on the UE requires extra processing power and hardware requires, increasing costs,

arbitration between multiple notification clients and other applications also increases cost, and

customisation of each client is required when a graphic user interface (GUI) is customised, again increasing costs.

Furthermore, it is difficult to add new services to an existing UE.

Such a notification method is standardised in ES 20239 10-3 ‘Open Service Access’ (OSA) ‘parlay X-web services Part 3: Call Notification’. In this, a client application has to register for a specific notification source and implements notification processing logic.

The present invention arose in an attempt to provide an improved method of implementing notification and response actions from multiple notification sources on a UE device and from our attempt to provide a system in which enables new easy addition of new notification sources and types.

According to the present invention there is provided a notification system for providing notifications, over a network, to a user equipment from a plurality of sources using at least two different protocols, comprising a notification agent arranged to receive notifications from said plurality of notification sources and which are intended for the user, the notification agent including means for receiving the notifications using a plurality of protocols according to the protocol of the individual sources and for providing notifications to the UE using a common protocol.

The notification agent preferably packages further data with the notification, representative of one or more parameters. The parameters, there may be only one or more of metadata, response actions and allowed to function, otherwise referred to as ‘{notification, action, metadata, functions}’ ({NAMF}) package.

The {NAMF} may be passed separately, together or otherwise from the notification agent to the client User Equipment (UE). They may optionally be transmitted via IPTV AS.

The system may further include pluggable processing logic for initial processing.

In a further aspect, the invention further provides a method of transmitting notifications from a plurality of agents, having different native protocols to user equipment over a networking comprising providing a notification agent adapted to receive notifications from the plurality of agents using their native protocol and to forward these notifications to the UE using a single protocol.

The notification client at the UE can be arranged to indicate to a user that the notification has been receive and, if appropriate, to present a range of possible actions to the user such that the user can select an action. If appropriate, the user can then pass back the selected action to the notification action agent for subsequent handling.

The invention further provides a notification agent, comprising means for receiving notifications from a plurality of sources each using a particular protocol, and for providing notification to a UE using a common protocol.

The invention further provides a notification system or agent including one or more of the novel features or combination of features disclosed and/or claimed herein.

Embodiments of the invention will now be described, by way of example only, with reference to the accompanying schematic drawings, in which:

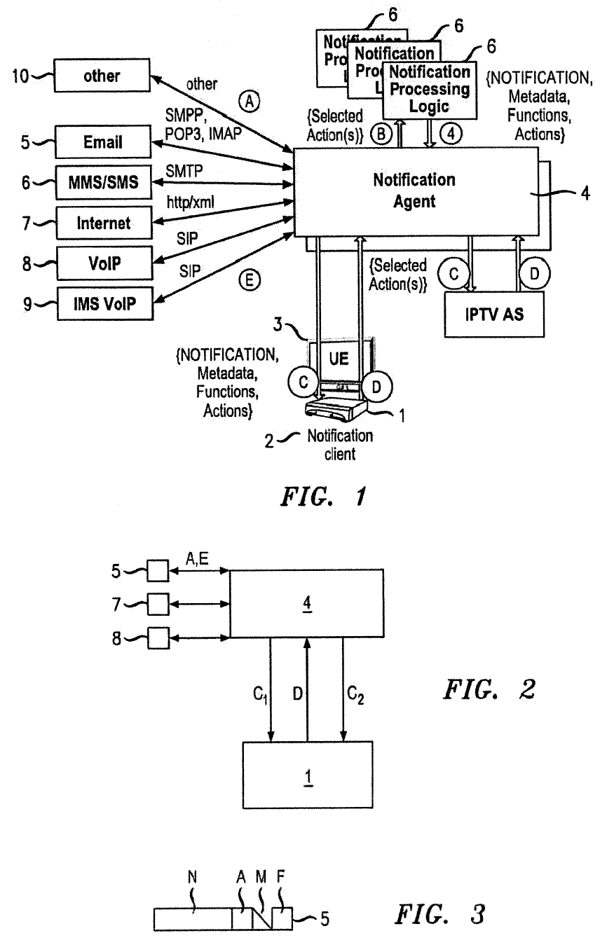

FIG. 1 shows a notification system;

FIG. 2 shows data flow;

FIG. 3 shows a data package;

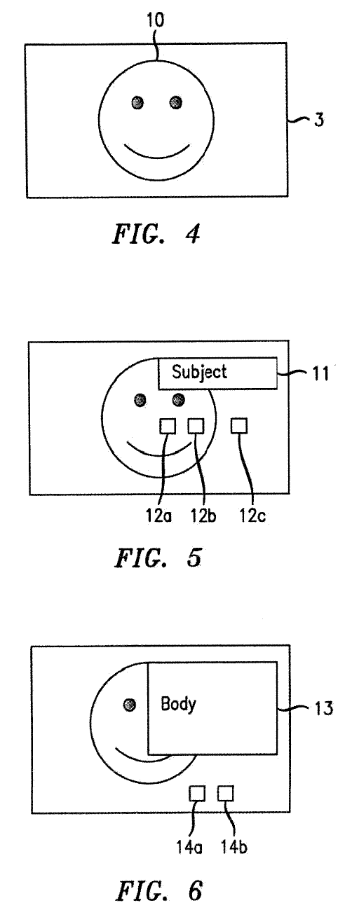

FIG. 4 shows a screen display on user equipment (UE);

FIG. 5 shows another screen display; and

FIG. 6 shows a first screen display.

Referring now to FIG. 1, a generalised system is shown for enabling user equipment 1 to be able to receive notifications from various sources. The UE 1 in this case is a IPTV apparatus including a set top box 2 connected to a display 3 although the STB may of course be integral with the display. Alternatively, the UE may be any other equipment such as a mobile phone, PDA or handheld terminal or any other device. Means (not forming part of the invention) may be provided which can indicate whether a particular user any time is using his mobile device or set top box or other device, so that communication can be addressed to the relevant device.

This is connected by any suitable communication channel, eg a closed IP network, opened Internet, wireless channel such as one using GPRS, UMTS, or other wireless or fixed line channels or by a combination of these or any other means to remote ‘middle ware’ provided at any suitable location on a network and which includes a notification agent 4. The notification agent 4 can receive and transmit data to and from a series of gateways to various communication services including email 5, MMS/SMS services 6, internet 7, VOIP services 8, IMS VOIP services 9 and many other types of services 10. These may well communicate with many different protocols. For example, email may be communicated using SMTP, POP3, IMAP or SMPP, communication with the internet may use HTTP/XML, VOIP may use SIP (session initiation protocol) as may IMS VOIP and other data sources may use similar or other protocols.

The notification agent 4 is arranged to collect/receive notifications from the multiple notification sources 5 to 10. Note that for scalability multiple agents can be used. Different modes can be used, eg a passive listening mode for incoming SIP or an active pull mode for internet updates, or other functions, for example. The incoming notifications are received from the various notification services via individual standard interfaces and this is shown as Step A in FIG. 1. The notification agent 4 includes functionality which processes the notification and converts it to a single notification format/protocol. In addition, the notification agent 4 packages metadata, response actions, presentation properties and allowed functions and these are referred to as ‘{notification, action, metadata, functions}’ ie {NAMF} package. A typical package is shown schematically in FIG. 3 where a package 5 includes the notification N, the range of possible actions A, metadata M and functions F and this package is transmitted to the UE 1. It will be described further below.

FIG. 1 shows a number of notification processing logic units 6 which are external, pluggable logic devices. The notification agent may pass incoming notifications from multiple information sources 5 to 10 to the notification project logic devices 6 for initial processing and this is shown as step B in FIG. 1.

Once the notification agent has packaged the {NAMF} they are then sent to the UE in step C. They may be passed together, ie as a package as shown in FIG. 3, or separately and the actual transport implementation/protocol may be any suitable one. The UE presents the notification and various options/actions to the user via the display 3. Optionally, notification can be delivered via an IPTV AS. The various options available are displayed to the user and he can select one of these. After the user selects a desired action, the UE passes back the selected action to the notification agent, step D. The notification agent then either processes the selected action or passes it to the relevant pluggable notification processing logic 6. Optionally, new notification and action selection is required to be delivered back to the UE. The notification agent then generates new NAMF and passes this to the STB. The further iterations are needed then steps B, C and D can be repeated literally.

If a response is need to the original notification source 5 to 10, then the notification agent 4 delivers the response via the standard (native) notification service interface on which the notification was originally received, step E.

FIG. 2 illustrates schematically the flow of data. Notifications from the various agents (in this case three agents; email 5, internet 7 and VOIP 8 are shown by way of example only) are received by a notification agent 4. This converts the notifications to a single notification format/signal protocol. It generates the {NAMF} package and transmits this to the UE 1. The UE 1 then displays the notification and any options available and the user selects an option. This is then transmitted back in step D to the notification agent 4. If further communication data transfer is required with the original agent then this occurs, otherwise the notification agent, possibly via notification processing logic 6 (not shown in FIG. 2 for clarity) then transmits a further {NAMF} on step C2 back to the UE. All communications between the notification agent 4 and the UE are done via a single protocol, via single communicational means, and thus notification processing logic is now no longer required at the UE itself. This is all done at the notification agent 4. Hence multiple notification sources can be supported. In fact, virtually unlimited extensions can be added onto the middle-ware based notification agent 4 to include emerging new notification sources (eg email, SMS, other sources) without any upgrades or modifications required to the UE.

In more general terms, the common notification agent NA4 in the middle-ware collects and receives notifications from multiple notification sources. The agent receives and processes notification and packages the notifications in a unified way with metadata, response actions, presentation properties, allowed function or other parameters or functionality and this package is then transmitted to the UE via a single notification channel. The UE therefore presents notifications to the user using package presentation properties and with a unified UE look and feel, independent of the nature of the source 5 to 10.

The actual {NAMF} package transmitted is shown by way of example in FIG. 3. In addition to the basic notification, as described various other information is packaged. This can include actions A. For example, if the notification relates to an email, then the ‘notification’ may comprise the subject only of the email. The ‘actions’ may comprise various actions that the user can take such a READ, SAVE, GET BODY, IGNORE and so on. The ‘functions’ may include information instructing the UE (for example a set top box) how to display the subject and the various actions, including position on screen, duration of display, size/colour, etc of selectable virtual buttons, and so on. Various types of ‘metadata’ can also be included and other functions or data can of course be included. The function F may include not only how to the display the various options, eg in the form of buttons on a display but also where to physically place these buttons on a display and also, if the user is viewing an IPTV program or other content at the time how to deal with the content which is already displayed. For example, information can be included as to whether the notification and the various functions should be overlaid on top of the existing display, or in place of the existing display or whether the existing display, if it is video content, should be allowed to continue whilst the notification is displayed or whether it should be blanked or frozen. Many other types of information may be transmitted. The information may also include instructions to automatically save video content so that when a notification is no longer displayed on the screen, the video content automatically restarts from where it stopped (ie a pause function).

The other elements, which might be transmitted, can relate to, for example, priority information. This might mean for example that if a message originates from a person on the user's buddy list or a person who for other reasons should be accorded greater priority, then that message is displayed more prominently, or perhaps displayed in preference to another message which might already be being displayed, or might alter any other presentation properties. It might be that the message comes from the child of a user and that the user therefore needs the message to be viewed very urgently. Many other types of logic will be apparent.

FIGS. 4 to 6 show example displays. In FIG. 4, a video 10 is being displayed on a display 3. When a notification arises, subject to the processing logic and instructions sent with the notification, it is displayed in a manner which is overlaid on the video image 10. In this case, the information is in the form of an email and the subject of the email is displayed in a first box 11. A plurality of action buttons 12a, 12b and 12c are also displayed, overlaid on the video image. 12a may read GET BODY, 12b may read DELETE, 12c may read SAVE and so on. There may be more or less than three buttons of course. The buttons 12a are selectable, perhaps by the user selecting button ‘1’ (for example) on a remote control, using a keyboard or other input means, or by direct touch using a touch screen, by using a remote control pointer or by any other means.

If the user selects choice 12a GET SUBJECT then this message is relayed back to the notification agent and then back to the email source 5 (FIG. 1). The subject is then obtained and transmitted back to the UE. FIG. 6 shows the subsequent display where the body (or full message) is displayed in box 13 together with some further options. These might read, for example, DELETE in box 14a and REPLY in box 14b. Many other options will, of course, be possible and there may be more or less than two possible reply buttons.

The embodiments of FIGS. 4 to 6 are of course schematic and are representative of where the message is an email. Other types of notification and display will be appropriate for other types of data.

There may for example be a scenario of content sharing. In this case, the notification agent 4 detects that new user-generated content has been uploaded by an uploading agent 10. The agent generates notification to the ‘buddies’ of the content originator to the effect that ‘You Have New Content From Fred’. This might be the notification that is put in the subject box 11 of FIG. 5. The possible actions might then read: READ DESCRIPTION, VIEW LATER, VIEW ASAP, IGNORE, SEND SMS TO FRED. The UE presents the notification ‘You Have New Content From Fred’, in the stand look and feel on the display and overlays the various actions. Note that the positioning of the actions can be determined by the package sent from the notification or according to predetermined rules on the UE.

If the user selects VIEW LATER then the UE passes the action to the notification agent. The agent then triggers content movement to cache the content for later view. A new notification can then be generated ‘The Content Will Be Ready For Viewing At 17:00. Actions None.’

In the above example, neither a specific content aware client nor any processing logic is required on the UE.

A further scenario relates to email received on an IPTV system. The notification agent 4 detects that a new email has been received. The agent generates notification to the IPTV UE ‘You Have Mail’. Actions READ, REPLY, IGNORE. The UE presents its notification in a standard look and feel and overlays the various actions. The user selects READ in this example. The UE passes this action to the notification agent. The agent then retrieves the email body using an appropriate email protocol such as IMAP, POP3. A new notification is then generated containing the mail body and a new set of actions. The cycle then continues. In this example, again, no specific email processing (POP3, IMAP, SMTP, etc) client nor any processing logic is required on the UE.

A yet further scenario relates to IPTV SMS notifications. A similar data flow to the above scenario will occur but a READ action is triggered to an SMS server on SMPP from the notification proxy. Again, no SMPP clients nor any processing logic is required on the UE itself. All of the above scenarios, and many others, may be achieved on the same UE using a common look and feel, neither any notification, specific client nor processing logic is required on the UE.

Many variations are possible. Notification presentation can be adapted so that if, for example, a low-priority message is received, this is delivered after the end of a TV programme (eg football match) the user is watching. Or it might be displayed in a less conspicuous manner but overlaid on the match.

The present invention removes notification processing logic from the UE. This enables multiple notification sources can be supported via a common and cost efficient way. It also allows virtually unlimited extensions, including new notification sources to be added to the middle where (ie at the server or infrastructure level) with UE upgrades or modifications. This is very cost efficient and also enables ‘pick and mix’ converged services to be made available depending on operator requirements.

The UE is not require to have any arbitration between multiple notification clients and other applications. Also no GUI customisation is required for each client since the UE can use a common look and feel for all notifications.

Thus, core processing of notifications is moved from the UE and instead is done in the notification agent (and/or by external pluggable logic) rather than at the UE. The user simply needs to select a response.

1. A notification system for providing notifications, over a network, to a user equipment (UE) from a plurality of sources using at least two different protocols, comprising a notification agent arranged to receive notifications from said plurality of notification sources and which are intended for the user, the notification agent including means for receiving the notifications using a plurality of protocols according to the protocol of the individual sources and for providing notifications to the UE using a common protocol.

2. A notification system as claimed in claim 1, wherein the notification agent provides further information to the UE with each notification, beyond the basic notification data.

3. A notification system as claimed in claim 2, wherein the information provided to the UE comprises one or more notification, action, metadata, function ({NAMF} data).

4. A notification system as claimed in claim 2, wherein the data includes data representative of one or more actions a user might wish to select in response to the notification.

5. A notification system as claimed in claim 4, wherein the data includes data representative of the positioning and/or display of the notification.

6. A notification system as claimed in claim 1, including means for allowing replies from a UE to be transmitted, over the common protocol to the notification agent and from there, if appropriate, to the original source using its individual protocol.

7. A notification system as claimed in claim 1, wherein the data provided from the notification agent to the UE is in a format that is displayed using a common look and feel, regardless of the protocol and look and feel of the notification from the original agent.

8. A notification system as claimed in claim 1, including pluggable logic elements.

9. A notification system as claimed in claim 1, wherein notification presentation and/or timing is adapted according to conditions and/or status.

10. A notification system as claimed in claim 1, wherein notification processing is done internally in the notification agent and/or by processing logic ‘pluggable’ into the notification agent.

11. A notification agent, comprising means for receiving notifications from a plurality of sources each using a particular protocol, and for providing notification to a UE using a common protocol.

12. A notification agent as claimed in claim 11, wherein the notification agent provides {NAMF} data to the UE.

13. A method of transmitting notifications from a plurality of agents, having different native protocols to user equipment over a network, comprising providing a notification agent adapted to receive notifications from the plurality of agents using their native protocol and to forward these notifications to the UE using a single protocol.

14. A method as claimed in claim 13, wherein the notification agent sends further data to the UE with the notification.

15. A method as claimed in claim 14, wherein the further data comprises one or more of {NAMF} data.

16. A method as claimed in claim 15, wherein the data provided from the notification agent to the UE is in a format that is displayed using a common look and feel, regardless of the protocol and look and feel of the notification from the original agent.

17. A method as claimed in claim 13, wherein the notification is received by a UE and displayed to the user of the UE with a series of selectable action which the user can select and reply, using the single protocol, to the notification agent which communicates with the plurality of agents using their native protocol to obtain further data or provide responses as determined by the user selection.
